(19) United States
(12) Patent Application Publication
(10) Pub. No.: US 2001/0032136 A1
(43) Pub. Date: Oct. 18, 2001

(54) Advertising method served by no margin shopping

(76) Inventor: Suk-Won Jang, Inchon City (KR)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 09/812,708

(22) Filed: Mar. 20, 2001

(30) Foreign Application Priority Data
Mar. 22, 2000 (KR) 14536

(51) Int. Cl. G06F 17/60

(52) U.S. Cl. 705/14

(57) ABSTRACT

The present invention relates to an advertising method served by no margin shopping which offers more satisfactory purchase to consumers without producing any margin, makes profits from its operation by means of advertising of commodities, allows consumers to buy commodities at a commodity cost. The advertising method served by no-margin shopping comprises: a first step in which the consumer connects to the AD server to search for a desired article, and then searches for the article by performing a keyword retrieval, or directly clicking a banner advertisement; a second step in which the AD page outputs the form of an advertisement that the consumer will see, and displays a single article while the costs of articles similar to the displayed article are displayed at the right side of the AD page by rotation with the advertisement of the manufacturer's image being displayed on the top of the AD page; a third step in which, when the consumer having seen the advertisement selects an article to purchase, and requests a purchase, a questionnaire 1 is displayed next to the article to purchase; a fourth step in which, when the questionnaire 1 is completed, the cost of the article to be purchased by the consumer is displayed; a fifth step in which, if the consumer is about to purchase another product after purchasing this article, the above steps are applied; a sixth step in which, the next time the consumer having conducted the purchase logs in, a questionnaire 2 is displayed; a seventh step in which, when another consumer purchases the same article, the first and second steps are carried out, and then the results of the questionnaire 2 filled in by the previous consumer are displayed on the bottom of the article; an eighth step in which the third through seventh steps are repeated; and a ninth step in which arranged questions are delivered to the manufacturer, and the manufacturer can reflect the results of the questions onto the consumers in price establishment, price adjustment, or future product development.

### BACKGROUND OF THE INVENTION

1. Field of the Invention

The present invention relates to an advertising method served by no margin shopping, and more particularly, to an advertising method served by no margin shopping which offers more satisfactory purchase to consumers without producing any margin, makes profits from its operation by means of advertising of commodities, allows consumers to buy commodities at a commodity cost (manufacturer's expected price), and enables the evaluation of the price and consumer preference of each product by a survey, unlike existing commodity exchanges.

2. Description of the Related Art

Recently, internet advertisements are increasing more and more. But, most of them are delivered to people in a forced manner, or are provided randomly to arouse people's interest, thereby bringing into not so much effect.

Sponsors wants consumers having an interest in their goods or image. However, internet advertising currently attracts internet users who have no intention to consume goods, but stick to small benefits of events from advertisements, rather than potential consumers. Therefore, it is very necessary to provide advertisements focused to a targeted potential consumers by running a no-margin shopping mall.

### SUMMARY OF THE INVENTION

It is, therefore, an object of the present invention to provide an advertising method served by no margin shopping which offers more satisfactory purchase to consumers without producing any margin, makes profits from its operation by means of advertising of commodities, allows consumers to buy commodities at a commodity cost, and enables the evaluation of the price and consumer preference of each product by a survey, unlike existing commodity exchanges.

### BRIEF DESCRIPTION OF THE DRAWINGS

The above objects, features and advantages of the present invention will become more apparent from the following detailed description when taken in conjunction with the accompanying drawings, in which:

FIG. 1 is a block diagram illustrating an advertising system according to the present invention; and

FIGS. 2 through 4 are block diagrams illustrating a sequence of operational steps of an advertising method according to the present invention.

### DETAILED DESCRIPTION

A preferred embodiment of the present invention will now be described with reference to the accompanying drawings.

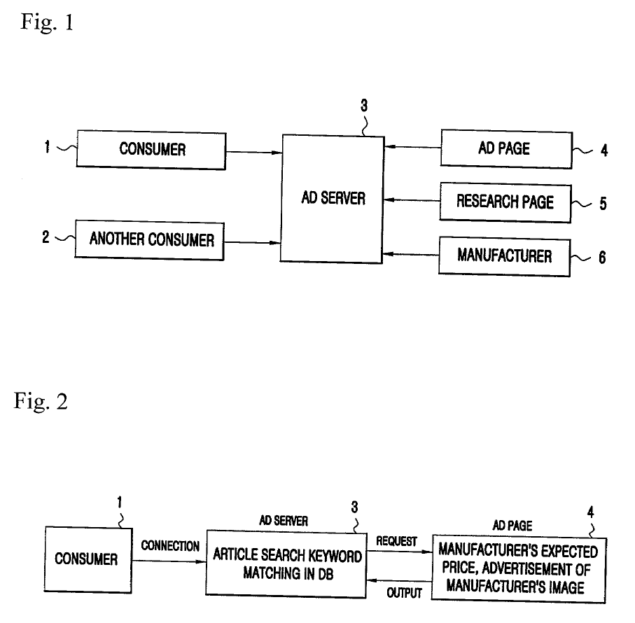

FIG. 1 is a block diagram illustrating an advertising system according to the present invention. The advertising system includes: a consumer 1 and another consumer 2 connected to an AD server to purchase an article; an AD server 3 performing an article search keyword matching in a DB (database), linking the consumer 1 to the article to purchase by matching it with the database of articles upon receipt of a purchase input from the consumer 1, and outputting a research data to the consumer 2 upon receipt of the request of the consumer 2; an AD page 4 outputting a manufacturer's expected price and an advertisement of the manufacturer's image to the AD server 3 according to the request of the AD server 3; a research page 5 outputting a research data to the AD server 3 according to the request of the AD server 3; and a manufacturer 6 outputting the results of checking the research data to the AD server 3 upon receipt of the research data from the AD server 3.

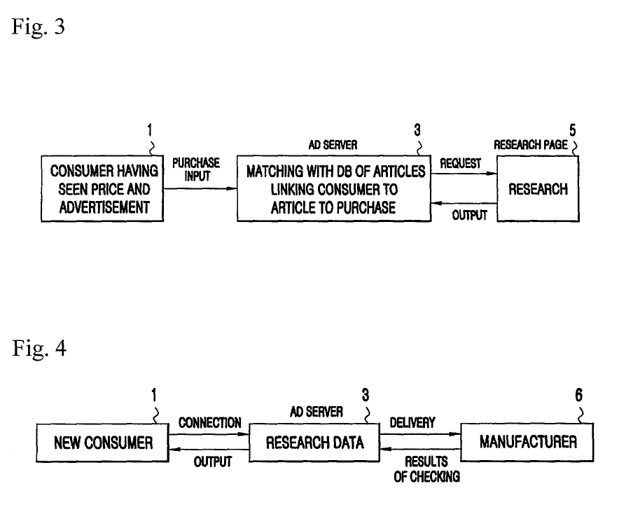

The operational steps of the present invention will now be described with reference to FIGS. 2 through 4.

In a first step, the consumer 1 connects to the AD server 3 to search for a desired article, and then searches for the article by performing a keyword retrieval, or directly clicking a banner advertisement.

In a second step, the AD page 3 outputs the form of an advertisement that the consumer will see, and displays a single article while the costs of articles similar to the displayed article are displayed at the right side of the AD page 3 by rotation with the advertisement of the manufacturer's image being displayed on the top of the AD page 3.

At this time, the above-mentioned cost is an amount of money suggested by the manufacturer 6, which is determined to be the manufacturer's expected price with no margin, not even 10%.

In a third step, when the consumer 1 having seen the advertisement as shown in FIG. 2 selects an article to purchase, and requests a purchase, a questionnaire 1 is displayed next to the article to purchase.

For example, the questionnaire 1 will be as follows.

1. How much do you think is the proper price of this article? (price 0000)

2. How do you feel at the brand name recognition of this manufacturer?

(familiar, or unfamiliar)

In a fourth step, when the questionnaire 1 is completed, the cost of the article to be purchased by the consumer 1 is displayed.

In a fifth step, when the consumer 1 is about to purchase another article after purchasing this article, the above steps are applied.

In a sixth step, the next time the consumer 1 having conducted the purchase logs in, a questionnaire 2 is displayed, said questionnaire 2 is limited to the articles that have been purchased at least once.

For example, the questionnaire 2 will be as follows.

1. Are you satisfied with the price of the article that you have purchased?

(satisfied, or unsatisfied)

2. Are you satisfied with the article that you have purchased? (satisfied, or unsatisfied)

(additional question 1. In the case that you are unsatisfied, describe what the problem of the article is)

In a seventh step, when another consumer 2 (the same consumer will do) purchases the same article, the first and second steps are carried out, and then the results of the questionnaire 2 filled in by the previous consumer 1 are displayed on the bottom of the article.

In an eighth step, the third through seventh steps are repeated.

In a ninth step, FIG. 3 is a conceptual view illustrating the flow and use of research data. Arranged questions are delivered to the manufacturer 6, and the manufacturer 6 can reflect the results of the questions onto the consumers 1 and 2 in price establishment, price adjustment, or future product development.

By delivering the standpoints of the consumers 1 and 2 to the manufacturer 6, the consumers 1 and 2 can demand a more reasonable price, and the manufacturer 6 can get the opportunity to determine an appropriate price according to the standpoints of the consumers 1 and 2.

As described above, the present invention allows consumers to buy a product at a low price and give the opportunity to evaluate the value of the product, and allows a manufacturer to understand the intention of potential consumers by implementing a direct transaction between a buyer and a manufacturer owing to the image of no margin articles, thereby obtaining a target advertising effect directly from internet users who are potential consumers.

In addition, the image of the manufacturer can be enhanced, and the consumers can have the opportunity to purchase products of a better quality at a lower price.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An advertising method served by no-margin shopping, comprising:
a first step in which the consumer connects to the AD server to search for a desired article, and then searches for the article by performing a keyword retrieval, or directly clicking a banner advertisement;
a second step in which the AD page outputs the form of an advertisement that the consumer will see, and displays a single article while the costs of articles similar to the displayed article are displayed at the right side of the AD page by rotation with the advertisement of the manufacturer's image being displayed on the top of the AD page;
a third step in which, when the consumer having seen the advertisement selects an article to purchase, and requests a purchase, a questionnaire 1 is displayed next to the article to purchase;
a fourth step in which, when the questionnaire 1 is completed, the cost of the article to be purchased by the consumer is displayed;
a fifth step in which, if the consumer is about to purchase another product after purchasing this article, the above steps are applied;
a sixth step in which, the next time the consumer having conducted the purchase logs in, a questionnaire 2 is displayed; a seventh step in which, when another consumer purchases the same article, the first and second steps are carried out, and then the results of the questionnaire 2 filled in by the previous consumer are displayed on the bottom of the article;
an eighth step in which the third through seventh steps are repeated; and
a ninth step in which arranged questions are delivered to the manufacturer, and the manufacturer can reflect the results of the questions onto the consumers in price establishment, price adjustment, or future product development.

2. The method according to claim 1, wherein, in the second step, the cost is an amount of money suggested by the manufacturer, which is determined to be the manufacturer's expected price with no margin, not even 10%.

3. The method according to claim 1, wherein, in the sixth step, the questionnaire 2 is limited to articles which have been purchased at least once when it is displayed.
